(19) United States
(12) Patent Application Publication
(10) Pub. No.: US 2011/0145269 A1
(43) Pub. Date: Jun. 16, 2011

(54) SYSTEM AND METHOD FOR QUICKLY DETERMINING A SUBSET OF IRRELEVANT DATA FROM LARGE DATA CONTENT

(75) Inventors: Andrew P. Kraftsow, Sedona, AZ (US); Mary K. O'Brien, Camarillo, CA (US)

(73) Assignee: RENEW DATA CORP.

(21) Appl. No.: 12/964,704

(22) Filed: Dec. 9, 2010

Related U.S. Application Data
(60) Provisional application No. 61/285,168, filed on Dec. 9, 2009.

(51) Int. Cl. G06F 17/30

(52) U.S. Cl. 707/766; 707/E17.074

(57) ABSTRACT

The present invention is directed to a system and method for quickly searching for all irrelevant data items in a data set based on a logical expression of an issue of interest to a user, which describes what the user is searching for. By performing this search, the size of data set that the system needs to search to find relevant documents is significantly reduced. The system is also configured to identify terms that are being used in possibly inconsistent ways with their normally accepted means so that code words can be uncovered. Additionally, the system is configured to search for Trade Terms that are not contained in any Dictionaries. In some embodiments, the system and method of the present invention utilize advanced automated search techniques including highlighting capability and use of query terms for determining subsets of relevant or irrelevant content data (in paper or electronic form).

### PRIORITY CLAIM

The present invention claims the benefit under 35 U.S.C. §119(e) of U.S. Provisional Patent Application No. 61/285,168 filed on Dec. 9, 2009 and entitled “System And Method For Quickly Determining A Subset Of Irrelevant Data From Large Data Content”, the contents of which are incorporated herein by reference and are relied upon here. The Provisional Patent Application No. 61/285,168 describes a system and method that operates independently or in conjunction with systems and methods described in related applications set forth below, the contents of each of which were incorporated by reference in the provisional application and therefore, constitutes a part of the technical description in the specification.

### RELATED APPLICATIONS

The present application describes a system and method that can operate independently or in conjunction with systems and methods described in pending application Ser. No. 11/449,400, filed on Jun. 7^{th}, 2006, and entitled “Methods for Enhancing Efficiency and Cost Effectiveness of First Pass Review of Documents” and pending application Ser. No. 12/025,715, filed on Feb. 4, 2008, and entitled “System and Method for Utilizing Advanced Search and Highlighting Techniques for Isolating Subsets of Relevant Content Data.” The contents of each of these applications in their entirety are incorporated herein by reference. International Applications PCT US2007/013483 (WO 2007/146107) and PCT/US2009/032990 (WO 2009/100081) also relate to the two applications referenced here and the contents of the PCT applications in their entirety are also incorporated herein by reference.

### BACKGROUND OF THE INVENTION

1. Field of the Invention

The present invention relates to systems and methods involving techniques for review and analysis of content data (in paper or electronic form) such as a collection of documents. It should be understood that paper form must be converted and represented in electronic form (e.g., by well-known optical character recognition (OCR) techniques for capturing paper and portable document format (PDF created by Adobe Systems) form that is searchable). More particularly, the present invention relates to a system and method for searching indexed content data to quickly and efficiently locate subsets of data that are either relevant or irrelevant to an issue of interest to a user. More particularly, this application relates to a system and method for quickly determining a subset of data that is irrelevant to an issue of interest in order to isolate only data that is of possible interest to the issue of interest. This approach reduces significantly the manpower and resources necessary to isolate any data that is relevant by quickly eliminating data of little or no interest and spending any effort only on data that is possibly relevant.

The present system and method also relates utilizing advanced organizing, searching, tagging, and highlighting techniques for identifying and isolating the irrelevant data and/or relevant data with a high degree of confidence¹ or certainty from large quantities of content data. ¹ Definition of Confidence Level per the US Department of Justice:

“The level of certainty to which an estimate can be trusted.” www.ojp.usdoj.gov/BJA/evaluation/glossary/glossary_c.htm

2. Background

In the current age of information, management of content data (e.g. documents in electronic or paper form) is a daunting task. Analysis of large amounts of content data is necessary in business for many purposes, for example, litigation, regulatory activities, due diligence studies, compliance management, investigations etc. For example, just in the context of a litigation proceeding in the United States, document discovery is an enormous endeavor and results in large expenses because documents must be carefully reviewed by skilled and talented legal personnel. This expensive exercise is undertaken both not only by the party seeking the discovery, but also by the party producing documents in response to document requests by the former.

Although review and analysis of data must still today be performed by skilled legal personnel, any efforts to automate this process of reviewing and organizing content data results in great savings. However, the automated methods that do exist today are largely unsophisticated and often yield results that are not entirely accurate. For example, the conventional methods of conducting discovery today first involve gathering up every document written or received by the named individuals during a designated time period and then having skilled legal personnel review these documents to determine if any is responsive to a specific discovery request. This approach is not only prohibitively expensive, but also time consuming. Not to mention that the burden of pursuing such conventional approaches is increasing with the increasing volumes of data that is compiled in this age of information.

In some cases, search engine technology is used to make the document review process more manageable. However, the quality and completeness of search results resulting from such conventional search engine techniques are often indefinite and therefore, unreliable. For example, one does not know whether the search engine used has indeed found every relevant document, at least not with any certainty.

The main search engine technique currently used is a keyword or a free-text search coupled with indexing of terms in the documents. A user enters a search query consisting of one or more words or phrases and the search system uncovers all of the documents that have been indexed as having one or more those words or phrases in the search query. As the search system indexes more documents that contain the specified search terms, they are revealed to the user. However, in many cases, such a search technique only marginally reduces the number of documents to be reviewed, and the large quantities of documents returned cannot be usefully examined by the user. There is absolutely no guarantee that the desired information is contained in any of the documents that are uncovered.

Furthermore, many of the documents retrieved in a standard search are typically irrelevant because these documents use the searched-for terms in a way or context different from that intended by the user. Words have multiple meanings. One dictionary, for example, lists more than 50 definitions for the word “pitch.” In ordinary usage by skilled humans, such ambiguities are not a significant problem because skilled humans effortlessly know the appropriate word for any situation. In addition, conventional search engine techniques often miss relevant content data because the missed documents do not include the search terms but rather include synonyms of the search terms. That is, the search technique fails to recognize that different words can almost mean the same thing. For example, “elderly,” “aged,” “retired,” “senior citizens,” “old people,” “golden-agers,” and other terms are used, to refer to the same group of people. A search based on only one of these terms would fail to return a document if the document used a synonym rather than the search term. Some search engines allow the user to use Boolean operators. Users could solve some of the above-mentioned problems by including enough terms in a query to disambiguate its meaning or to include the possible synonyms that might be used, but clearly this takes considerable effort.

However, unlike the familiar internet searches, where a user is primarily concerned with finding any document that contains the precise information the user is seeking, discovery in a litigation is about finding every document that contains information relevant to the subject. An internet search requires a high degree of precision, whereas the discovery process requires not only a high degree of precision, but also high recall.

Continuing with the example of discovery in litigation, search queries are typically developed with the object of finding every relevant document regardless of the specific nomenclature used in the document. This makes it necessary to develop lists of synonyms and phrases that encompass every imaginable word usage combination. In practice, the total number of documents retrieved by these queries is very large.

Methodologies that rely exclusively on technology to determine which content data in a vast collection of data is relevant to a lawsuit have not gained wide acceptance regardless of the technology used. These methodologies are often deemed unacceptable because the algorithms used by the systems to determine relevancy are incomprehensible to most parties to a law suit.

It is often the case that large amounts of data sets only have a few possibly responsive documents. Currently all known methods of searching for relevant documents search purely for relevant documents, which can be quite an intensive and exhausting task.

There is a dire need for improved techniques that facilitate efficient isolation of irrelevant content data to eliminate that data with the ultimate goal of isolating a subset of relevant content data with a high degree of certainty for purposes of reviewing and analyzing the relevant data for its intended purpose. In addition, there is an ongoing need for improved searching, tagging, and highlighting techniques to ensure increased efficiency during such review and analysis.

### SUMMARY OF THE INVENTION

The present invention relates to a system and method for searching indexed content data to quickly and efficiently locate subsets of data that are either relevant or irrelevant to an issue of interest to a user. The present system and method quickly and efficiently determines a “subset” of data that is irrelevant to an issue of interest in order to isolate only data that is of “possible” interest to the issue of interest. This approach and technology significantly reduces the manpower and resources necessary to isolate any data that is relevant, by quickly eliminating data of little or no interest and spending any effort only on data that may be possibly relevant.

In accordance with one embodiment, the system and methods of the present invention perform an advanced search of vast amounts of content data, believed to be a relatively low amount of relative data (less than 50%) based on query terms, in order to retrieve a subset of responsive content data that is irrelevant. Documents are searched to show absolute irrelevance with respect to the query terms.

In accordance with yet another embodiment of the invention, the system and method considers all content data in a thread of correspondence (for example, an e-mail) and includes it in the subset of irrelevant data that is isolated. The system also scans the content data in the thread and automatically identifies other data of interest, for example, contained in attachments and includes that data as well in the responsive set.

In accordance with an entirely automated embodiment of the system and method, configured to operate without human operators, the system has an architecture, which incorporates an automatic query-builder. With this automated embodiment, human operators simply highlight the parts of the content data or document that seem pertinent to an issue(s) and the intelligent capabilities of the system, such as the software components of the system architecture, automatically formulate precise Boolean queries utilizing the highlighted parts of the text and then utilize those precise Boolean queries to search for irrelevant data. The highlighted text that is identified need not be contiguous. The system architecture utilizes functionality to construct the query. To construct the query, the system runs the highlighted text through a part-of-speech tagger module, which eliminates various parts of speech and eliminates stop-words. The system has a capability, which executes some rules about the operator “within” and then builds the query. The automatic query builder hardware and software of the system architecture also permits expert users to make some “AND” or “OR” decisions about non-contiguous highlights, for example, by holding down the CONTROL key on the computer keyboard, while executing the highlighting function. This automatic query builder module significantly reduces the need for human operators. In accordance with this embodiment, users read the document, highlighting whatever language strings relate to the issues that they seek to address. The user associates each highlighted text to an issue (or multiple issues). When the users are finished with this exercise, the automated query builder forms the queries, runs them in the background, and bulk tags the search result documents. The system also displays a sample of randomly selected results so that the user can test the statistical certainty that the query was precise.

To accomplish the above embodiments, the system takes the input query, whether generated through an automated or manual means and generates every possible synonym of the query terms and generates synonym rings for each term and its synonyms. The system then performs an AND Boolean operation taking every possible combination of the synonym rings and generates a query from the combinations. A document is then determined to be irrelevant when it is not responsive to any of the queries that are posed. The remaining set of “possibly” relevant data is much smaller than the original, entire set of data, as a result of which the remaining set can be more easily and efficiently searched for relevant data.

Further technical functionalities of the system and method incorporated by reference in the provisional application are indicated here as part of this description. The system and method described here are used for isolating relevant data from a subset of data. It should be understood that any of the functionalities described here for isolating relevant data from a given set, can also be used to isolate irrelevant data. The present invention also relates to a system and method for utilizing advanced searching, tagging, and highlighting techniques for identifying and isolating irrelevant or relevant data with a high degree of certainty from large quantities of content data (in paper or electronic form).

In accordance with a further aspect, the system and methods of the present invention can perform an advanced search of vast amounts of content data based on query terms, in order to retrieve a subset of responsive content data. In one exemplary embodiment, a probability of relevancy or degree of certainty is determined for a unit of content data or document in the returned subset, and the content data or document is removed from the subset if it does not reach a threshold probability of relevancy. A statistical technique can be applied to determine whether remaining documents (that is, not in the responsive documents subset) in the collection meet a predetermined acceptance level.

In accordance with yet another aspect of the invention, the system considers all content data in a thread of correspondence (for example, an e-mail) and includes it in the subset of relevant data, when the user desires to find relevant data from a subset of documents. The system also scans the content data in the thread and automatically identifies other data of interest, for example, contained in attachments and includes that as well.

In accordance with still another aspect of the invention, the system assures greater efficiency, by taking the following steps: (a) randomly selecting a predetermined number of documents from remaining content data; (b) reviewing the randomly selected documents to determine whether the randomly selected documents include additional relevant documents; (c) if additional relevant documents are retrieved, identifying one or more specific terms in the additional content data that renders the data relevant and expanding the query terms with those specific terms, and running the search again with the expanded query terms.

In yet a further aspect of the system and methods described here, a feedback loop criteria, ensures that content data that is relevant with a high degree of certainty and probability is shown early on to human reviewers. In traditional content data review, content data that is isolated and queued up for consideration is usually ordered by custodian and chronology. Even if some other method is used, the order generally remains fixed throughout the isolating process. To accomplish this, the system and methods here use a heuristic algorithm for selecting the next content data unit or document that takes into account the disposition of the content data or documents previously seen by the reviewers. The algorithm operates in both an inclusive and an exclusive direction. Content data and documents are excluded from the isolating process if they contain any previously seen relevant language strings. To effect this, the database must be continuously updated during the isolating process to reflect the strings that human reviewers may discover. The system described here permits modification of search routines based on human input of attributes contained in content data found to be relevant. Hence, content data in a queue for consideration may be moved up. For example, attributes such as author, date, subject (if email), size, document type and social network may be used.

In yet a further aspect of the invention, instead of finding all content data relevant to an issue and with a high degree of certainty, the system can search and isolate certain key content data of particular interest (e.g. “privileged” or “hot” documents). The system and methods described here accomplish this with two steps: 1) a re-evaluation of the database unitization and 2) a recalculation of the Poisson distribution² criteria. Poisson distribution criteria demands that the relevance of object A has no impact on the relevance of object B. To isolate “hot” data content, the system considers not only the text but also the author and recipient of the text. Therefore, the system searches for privileged or “hot” documents. The system has to remove duplicate documents at a different level and then has to recalculate the formulas based on the expected density of the subject matter that is being search to determine sample size. To isolate select privileged data, the system uses precise ² In probability theory and statistics, the Poisson distribution is a discrete probability distribution that expresses the probability of a number of events occurring in a fixed period of time if these events occur with a known average rate and independently of the time since the last event. and rigorous string identifications such as the topic in conjunction with noun, verb, or object sets.

In accordance with an entirely automated aspect of the system, without human operators, the system incorporates an automatic query-builder. With this aspect human operators simply highlight the parts of the content data or document that seem relevant to an issue(s) and the software components of the system automatically formulate precise boolean queries utilizing the highlighted parts of the text. The highlighted text need not be contiguous. To construct the query, the system runs the highlighted text through a part-of-speech tagger, which eliminates various parts of speech and eliminates stop-words. The system executes some rules about the operator “within” and then builds the query. The automatic query builder aspect of the system also permits expert users to make some “AND” or “OR” decisions about non-contiguous highlights by holding down the CONTROL key while executing the highlighting function. This automatic query builder significantly reduces the need for human operators. In accordance with this aspect, users read the document, highlighting whatever language strings relate to the issues that they seek to address. The user associates each highlighted text to an issue (or multiple issues). When the users are done with this exercise, the automated query builder forms the queries, runs them in the background and bulk tags the search result documents. The system also displays a sample of randomly selected results so that the user can test the statistical certainty that the query was precise.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. It should be understood that these drawings depict only typical embodiments of the invention and therefore, should not be considered to be limiting of its scope. The invention will be described and explained with additional specificity and detail through the use of the accompanying drawings in which:

FIG. 1 is a block diagram of a computer system or information terminal on which programs operate to implement the methods of the inventions described here.

FIG. 2 is a flow chart showing the Information Flow of the Overall system and method;

FIG. 3 is a flow chart showing the setup procedure for the system and method described here; and

FIG. 4 is a flow chart showing the searching and query generation procedure. The figures from related U.S. application Ser. No. ______, one of the applications incorporated by reference in the provisional application are indicated below.

FIG. 5 is a block diagram of a computer system or information terminal on which programs can run to implement certain methods of the inventions described here.

FIG. 6 is a flow chart of an exemplary method of reviewing either vast collections of content data or data that separated from data determined to be irrelevant in order to identify a subset of relevant content data.

FIG. 7 is a flow chart of an exemplary method for reviewing either vast collections of content data or data separated from data determined to be irrelevant from which to further identify relevant content data.

FIG. 8 is a flow chart of a method for reviewing a collection of content data or documents (either an entire collection or a subset separated from data determined to be irrelevant), in order to identify relevant documents from the collection, according to another exemplary embodiment.

FIG. 9 is a flow chart of a method for reviewing a collection of content data or documents to identify relevant documents from the collection (subset of entire data or data separate from irrelevant data that is determined), according to another exemplary embodiment.

FIG. 10 is a flow chart of a method for reviewing a collection of content data or documents (either entire set of data or a subset of data isolated from data determined to be irrelevant data) to identify relevant documents from the collection, according to another exemplary embodiment.

FIGS. 11A and 11B represent a flow chart for a workflow of a process including application of some of the techniques discussed here.

FIG. 12 is a flow chart of an automated query builder feature of the present system and method.

FIG. 13 is a flow chart of an example illustrating a database containing emails, attachments, and stand alone files from a corporate network, all which constitute the content data for review.

FIG. 14 is a flow chart of an exemplary embodiment of a “smart highlighter” feature of the present system and method.

### DETAILED DESCRIPTION OF THE INVENTION

Various embodiments of the invention are described in detail below. While specific implementations involving electronic devices (e.g., computers) are described, it should be understood that the description here is merely illustrative and not intended to limit the scope of the various aspects of the invention. A person skilled in the relevant art will recognize that other components and configurations may be easily used or substituted than those that are described here without parting from the spirit and scope of the invention.

The computer system referenced as “Anagram” has an architecture with functionalities that are configured to identify documents that are not relevant to a “query” posed, which is assembled from a “logical expression of the issue,” in order to quickly identify a data set of documents with little or no relevance to the query. Although not required, this invention will be described in the general context of computer-executable instructions, such as program modules within a system architecture comprising hardware and software. Generally, program modules include routines, programs, objects, scripts, components, data structures, etc., that performs particular tasks or implement particular abstract data types. Moreover, those skilled in the art will appreciate that the invention may be practiced with any number of computer system configurations including, but not limited to, distributed computing environments where tasks are performed by remote processing devices that are linked through a communications network. In a distributed computing environment, program modules may be located in both local and remote memory storage devices. The present invention may also be practiced in and/or with personal computers (PCs), hand-held devices, multiprocessor systems, microprocessor-based or programmable consumer electronics, network PCs, minicomputers, mainframe computers, and the like.

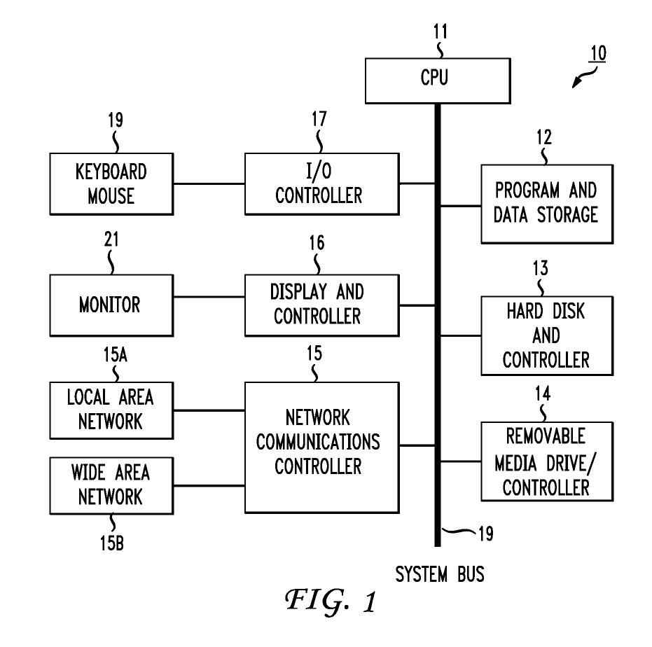

FIG. 1 is a schematic diagram of an exemplary computing environment in which the present invention may be implemented. The present invention may be implemented within a general purpose computing device 10 in the form of a conventional computing system. One or more computer programs may be included in the implementation of the system and method described in this application. The computer programs may be stored in a machine-readable program storage device or medium and/or transmitted via a computer network or other transmission medium.

Computer 10 includes CPU 11, program and data storage 12, hard disk (and controller) 13, removable media drive (and controller) 14, network communications controller 15 (for communications through a wired or wireless network (LAN or WAN, see 15A and 15B), display (and controller) 16 and I/O controller 17, all of which are connected through system bus 19. Although the exemplary environment described here employs a hard disk (e.g. a removable magnetic disk or a removable optical disk), it should be appreciated by those skilled in the art, that other types of computer readable media, which can store data that is accessible by a computer, such as magnetic cassettes, flash memory cards, digital video disks, Bernoulli cartridges, random access memories (Rams), read only memories (ROMs), and the like, may also be used in the exemplary operating environment.

A number of program modules may be stored on the hard disk 13, magnetic disk, and optical disk, ROM or RAM, including an operating system, one or more application programs, other program modules, and program data. A user may enter commands and information into the computing system 10 through input devices such as a keyboard (shown at 19), mouse (shown 19) and pointing devices. Other input devices (not shown) may include a microphone, joystick, game pad, satellite dish, scanner, or the like. These and other input devices are often connected to the central processing unit 11 through a serial port interface that is coupled to the system bus, but may be connected by other interfaces, such as a parallel port, game port or a universal serial bus (USB). A monitor 21 or other type of display device is also connected to the system bus via an interface, such as a video adapter. In addition to the monitor 21, computers typically include other peripheral output devices (not shown), such as speakers and printers. The program modules may be practiced using any computer languages including C, C++, assembly language, and the like.

Some examples of the methods implemented for reviewing a collection of content data or documents to identify relevant documents from the collection in accordance with exemplary embodiments of the present invention are described below.

The system illustrated in FIG. 1 first runs a setup situation where the system (CPU 11) indexes all data using a Boolean engine and extracts vocabulary words, which are all of the words contained in the data, and tracks the location and frequency of the word. This indexing operation is performed by an indexing module. All dictionary words are then processed through a different flow from the non-dictionary words. Dictionary words are words that are known in advance, words that are likely found in a dictionary, or by some other means, where words are defined and classified. A dictionary may be a specialized dictionary, such as the IEEE dictionary or any other such technical dictionary. The lemma of each dictionary word is identified. For example, the words “running,” “runs,” and “ran” would all be identified as “run” and then all dictionary words are hierarchically organized by the part of speech to which they belong. All non-dictionary words are verified with a spell checker and all words that are identified by the system to be possible proper spellings for the non-dictionary words are linked with the improper spellings. By this linking, when the properly spelled words are searched by the system, the system can take the improperly spelled words into consideration as well. This operation performed on the dictionary words by the system is then performed on those dictionary words that have been spell-checked. For words that do not have proper spellings identified with them after a spell checking operation, the system sends the words to a manual operator interface by which an operator can properly classify the words. These words, for example, are trade terms or trade names that do not appear in a dictionary or are words that are improperly spelled to such a degree that the spell checker cannot select a proper spelling. If they are words not recognized by a dictionary, the words are simply hierarchically organized by the parts of speech that they belong to.

The next step of the process is the actual identification process (performed by an identification module), which begins with the building of various queries from an input Logical Expression of Issue (LEI). The system then identifies all synonyms of each of the LEI'S concepts and creates and builds synonym rings from each, which represent every synonym for each concept of the LEI. The system then creates every possible Boolean combination of the synonym rings for each query term preserving concept proximity expressions in the LEI. By way of one example, the system takes an input LEI A && W/5 B && P/1 C, where A has 2 Synonyms A1 and A2, B has 1 Synonym, and B1 and C have no Synonyms, and then generates the following additional queries: A && W/5 B1 && P/1 C, A1 && W/5 B && P/1 C, A1 && W/5 B1 && P/1 C, A2 && W/5 B && P/1 C and A2 && W/5 B1 && P/1 C. Where W/5 means that the proceeding word is within five words of the preceding word and where P/1 means that the preceding word is within one paragraph from the preceding word. The entire index is then searched and the system tags all of the results with their appropriate issue code, which defines why they are results and optionally highlights the query terms contained in them. After the system searches for all of the generated queries, the system tags all of the non-responsive documents as irrelevant.

The system by this operation identifies every item that could be matched to the query terms, regardless of the possible relevance of the various synonyms to provide a high level of confidence in the non-responsive documents being irrelevant to the initial query. There would then be left from the results, items that might be irrelevant based on the definition of the synonyms or items that do not reach some adequate level of relevancy, but do not have a near zero probability of relevancy as the non-responsive set have after the search is performed.

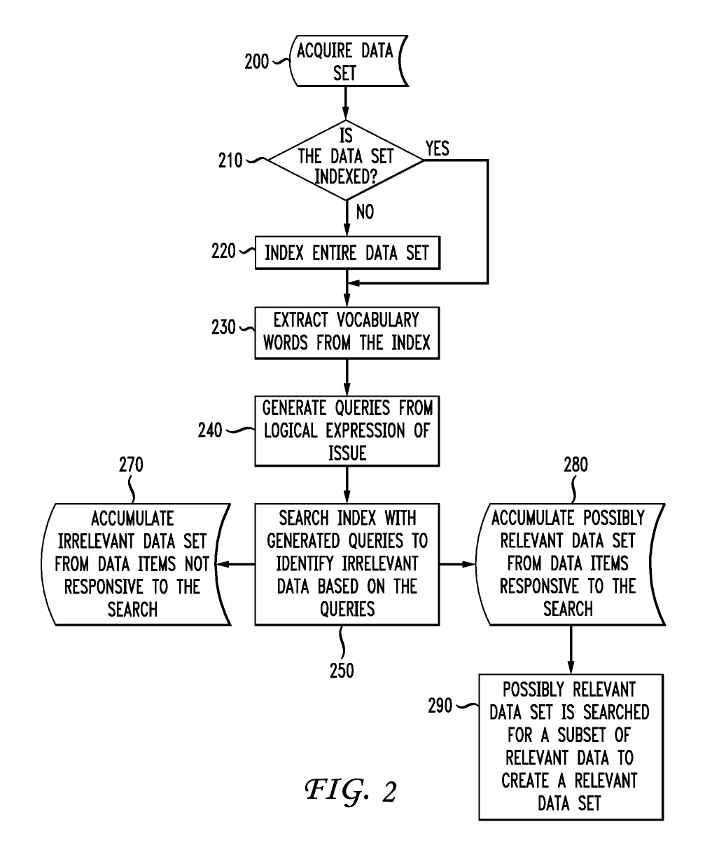

FIG. 2 illustrates the general flow of data through the systems and methods as recited in this specification. Block 200 illustrates the step of acquiring the data set, which may be any collection of data. It may be a “Mail” database file or it may simply be a large collection of documents and files. At step 210, the system checks to see if the data set acquired is already indexed. If the data set is already indexed, the system advances to step 230, at which point, the system takes the necessary steps to index the data as illustrated at step 220. After step 230, the system advances to step 240, where the system takes an input of a “Logical Expression Unit” and creates synonym rings, which are used to generate queries. At step 250, the system searches the set using the generated queries to identify irrelevant data based on the queries, the search returns a responsive set of data items. The system proceeds to step 270, where a data set of irrelevant data is created from the data items that were not responsive to the search in step 250. At step 280, a data set of possibly relevant data items is created from the responsive set of data items returned by step 250, which is then fed into a search engine to find the relevant data at step 290.

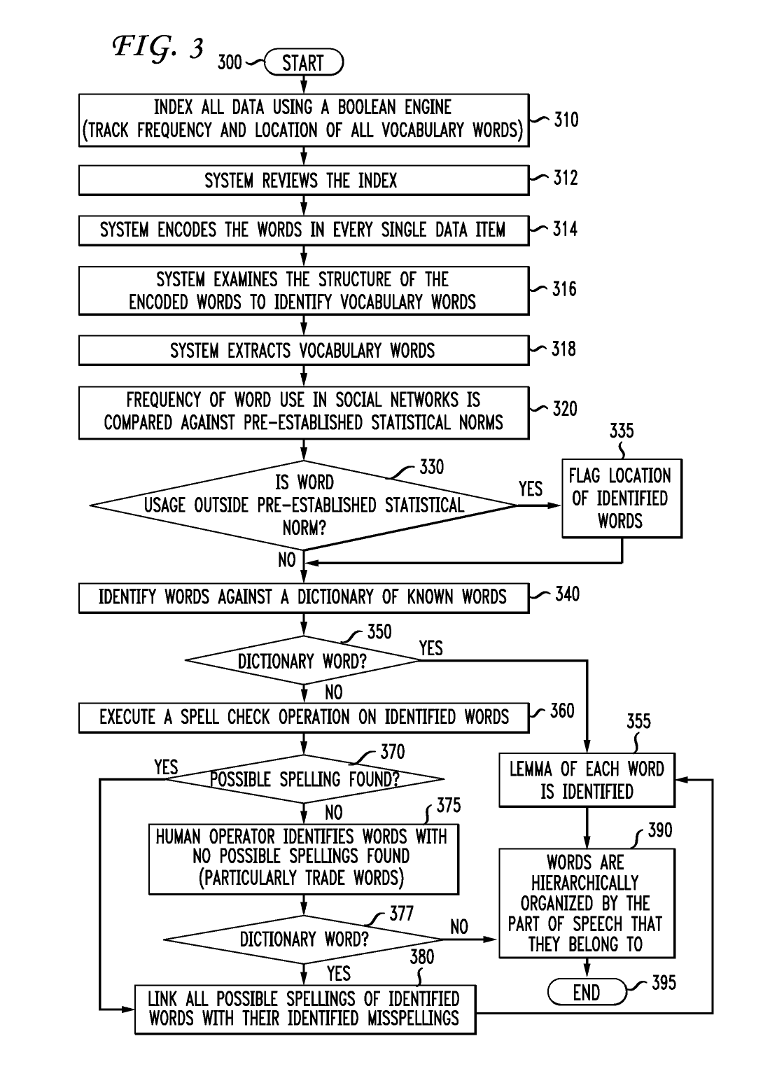

FIG. 3 shows the general flow for the setup of the input acquired data set. The system, at step 310, indexes and extracts all vocabulary words from within the acquired data set. This step includes tracking the frequency and location of all of the vocabulary words. At step 312, the system reviews the index created in step 310. At step 314, the system encodes the words in every single data item. At step 316, the system examines the structure of the encoded words to identify vocabulary words. At step 318, the system extracts all vocabulary words. At step 320, the system uses the communications between social networks and attempts to identify whether or not words are being used outside of established statistical norms. At step 330, words that are identified to have occurrence frequencies beyond statistical norms are sent to a point in the operations, illustrated at step 335 where the word locations are identified. If the word usages are within the statistical norms words that are defined, then the system (at step 340) identifies the words against a dictionary or words. The dictionary may be a standard dictionary, or any other source of words associated with definitions and characterizations. At step 350, the system takes the words that are identified as dictionary words and identifies the Lemma of the words (at step 355). For example, the system modifies “running” to “run,” and then organizes the words hierarchically by the part of speech that the word belongs to (illustrated at step 390).

If the words are not dictionary words, at step 350, the system forwards the words to a point in the systems' operations, illustrated at step 360, where the system performs a spell check on the words. If no possible spellings for the words are found, the system enables review of the words by a human operator (at block 375) so the human operator can allow the words. These words are most likely to be trade terms or names and as such would not be in a dictionary. They, however, may also be misspelled words, in which case the human operator can correct these miss spellings. If the words were not dictionary words, but rather trade terms, the words are forwarded to the next step in the operations, from block 377 to block 390. If, however, the words are dictionary words, the system forwards the words to step 380 of the operations, where the proper spellings are linked to the improper spelling. This allows for the operation when the system searches for the proper spelling of the misspelled words. The search automatically references the misspelled occurrences. If at step 370, there were possible proper spellings, the words are passed on to step 380 to associate all of the possible proper spellings with their misspellings. After step 380, the system continues onto step 355. After step 390, the setup operation ends at step 395.

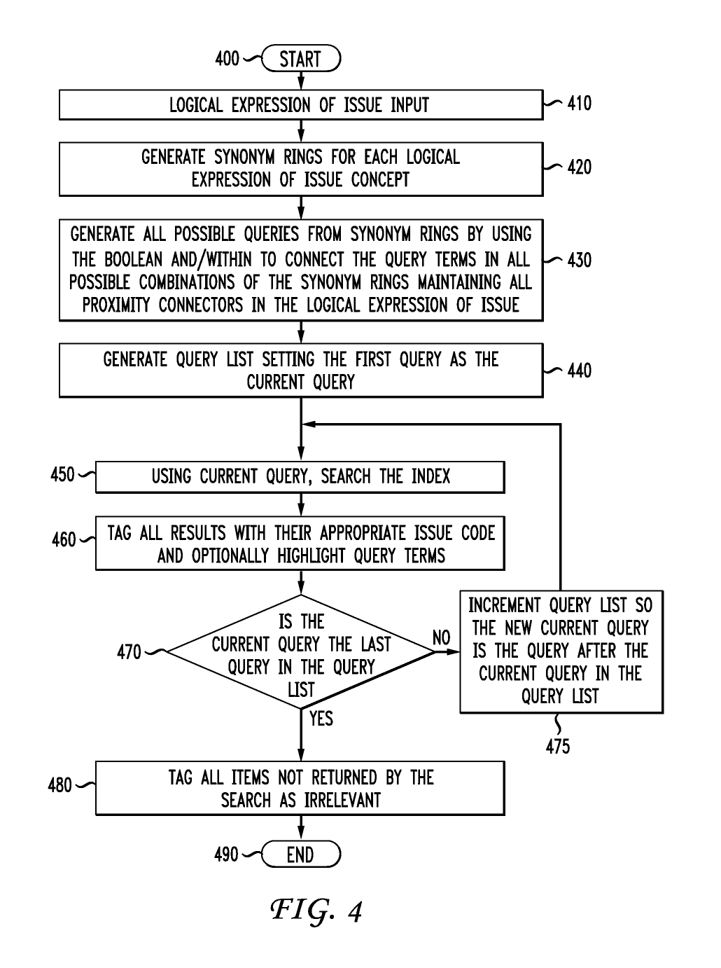

FIG. 4 is the basic flow for the query generation and the searching of the indexed acquired data set. A LEI is input into the system at step 410. At step 420, the system takes the LIE and breaks it up into its individual concepts. Each concept is then used to create a synonym ring, which contains the concept and all of its possible synonyms. At step 430, the system performs a Boolean operation (e.g. AND) and adds a single concept from each synonym ring together and maintains all proximity characters between concepts in the LEI, such as maintaining (e.g. WITHIN) character ranges, paragraph ranges, etc. This creates every possible combination of the terms in the synonym rings. For example, if there were three concepts in the LEI where each concept had five possible synonyms, the system would generate 125 queries. At step 440, the system places all of the Queries into an ordered list. This could also be a linked list or any means of organizing all of the queries in some logical order and sets the first query as the current query. The system, at step 450, searches the data set using the current query. At step 460, all of the results that are responsive to the query are tagged with their appropriate issue code and are optionally highlighted. These items can also be removed as being possibly relevant items, however this yields mixed results, as it would speed up the remaining queries, but it would also leave items not necessarily entirely tagged or highlighted based on what could have been highlighted had subsequent queries been run on them. At step 470, the current query is checked to see if it is also the last query. If the query is not the last query, the system advances the query list and makes the subsequent query the current query and returns to step 450. If at step 470, the query is the last query, the system advances to step 480. At step 480, the system tags all of the items that were not returned by any of the queries as being responsive as being irrelevant items. These items are then segregated from the possibly relevant items and the system operations end at step 490.

To further search for relevant data from the possibly relevant items identified (once the irrelevant data is discarded), the systems and methods used involve techniques for organization, review and analysis of content data (in paper or electronic form), such as a collection of documents. The systems and methods described here utilize advanced searching, tagging, and highlighting techniques for identifying and isolating relevant content data with a high degree of confidence³ or certainty from large quantities of content data. It should be understood that any of the operations described below can also be used to first isolate the irrelevant data. ³ Definition of Confidence Level per the US Department of Justice:

“The level of certainty to which an estimate can be trusted.” www.ojp.usdoj.gov/BJA/evaluation/glossary/glossary_c.htm

The system search techniques used here search the content data based on language “strings.” In addition, the system uses Poisson-based mathematics to predict how much content data or how many documents would need to be reviewed before finding every relevant language string in the collection of content data. This is based on the principle that relevant language strings are distributed in content data in accordance with the theory of Poisson distribution. Moreover, the number of relevant strings in a given amount of content data or document is a function of the number of issues addressed, not a function of the size of the content data. Furthermore, the number of relevant language strings, on average, does not exceed 50 per issue regardless of the size of the collection of content data. Because the system uses Poisson-based mathematics, the system retrieves content data with relevant language strings quickly and efficiently, thereby saving unnecessary review of irrelevant data by skilled humans. Review of irrelevant data without use of this system was inevitable because the data presented was organized by custodian and chronology.

The system and techniques here additionally use Poisson-based statistical sampling to prove that isolation of relevant content data is accomplished with a stated degree of certainty. In other words, that all content data with relevant language strings is retrieved. The system uses a defined set of rules and a Boolean search engine to find every occurrence of relevant language strings. By using a bulk tagging mechanism, and applying specific tagging rules and naming conventions, the system marks the relevant documents in a manner that is auditable. This way of tagging yields two benefits—1) a user knows exactly why each document was tagged as relevant; and 2) a user can “undo” the tagging if a language string is re-classified as non-relevant at a later date.

In some instances, documents are delivered to an assembly line of skilled humans to review documents in batches (the most common situation). Identifying relevant language strings in prior batches significantly decreases the time to review documents in future batches.

Full citations for a number of publications may be found immediately preceding the claims. The disclosures of these publications are hereby incorporated by reference into this application in order to more fully describe the state of the art as of the date of the methods and apparatuses described and claimed herein. In order to facilitate an understanding of the discussion which follows one may refer to the publications for certain frequently occurring terms which are used herein.

Again, although not required, the system architecture is described the general context of computer-executable instructions, such as program modules. Generally, program modules include routines, programs, objects, scripts, components, data structures, etc. that performs particular tasks or implement particular abstract data types. Moreover, those skilled in the art will appreciate that the invention may be practiced with any number of computer system configurations including, but not limited to, distributed computing environments where tasks are performed by remote processing devices that are linked through a communications network. In a distributed computing environment, program modules may be located in both local and remote memory storage devices. The present invention may also be practiced in personal computers (PCs), hand-held devices, multiprocessor systems, microprocessor-based or programmable consumer electronics, network PCs, minicomputers, mainframe computers, and the like.

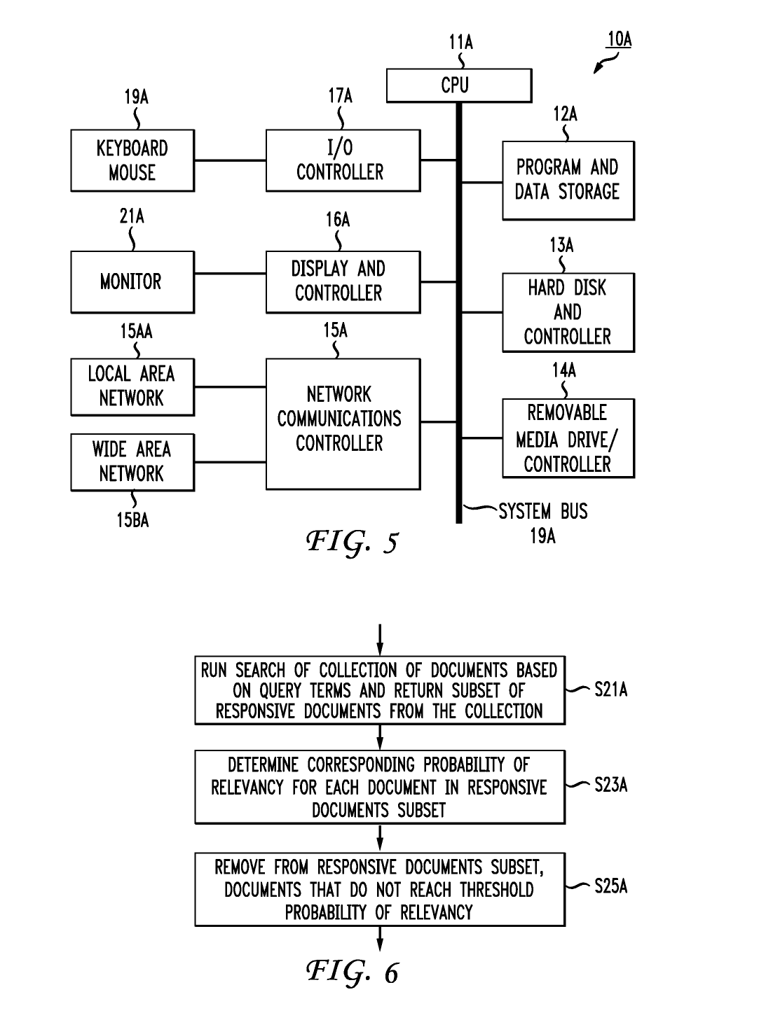

FIG. 5 is a schematic diagram of an exemplary computing environment in which the present system is implemented and operated. The present system architecture may be implemented within a general purpose computing device 10A in the form of a conventional computing system. One or more computer programs may be included in the implementation of the system and method described in this application. The computer programs may be stored in a machine-readable program storage device or medium and/or transmitted via a computer network or other transmission medium.

Computer 10A includes CPU 11A, program and data storage 12A, hard disk (and controller) 13A, removable media drive (and controller) 14A, network communications controller 15A (for communications through a wired or wireless network (LAN or WAN, see 15AA and 15BA), display (and controller) 16A and I/O controller 17A, all of which are connected through system bus 19A. Although the exemplary environment described herein employs a hard disk (e.g. a removable magnetic disk or a removable optical disk), it should be appreciated by those skilled in the art that other types of computer readable media which can store data that is accessible by a computer, such as magnetic cassettes, flash memory cards, digital video disks, Bernoulli cartridges, random access memories (Rams), read only memories (ROMs), and the like, may also be used in the exemplary operating environment.

A number of program modules may be stored on the hard disk 13, magnetic disk, and optical disk, ROM or RAM, including an operating system, one or more application programs, other program modules, and program data. A user may enter commands and information into the computing system 10A through input devices such as a keyboard (shown at 19A), mouse (shown 19A) and pointing devices. Other input devices (not shown) may include a microphone, joystick, game pad, satellite dish, scanner, or the like. These and other input devices are often connected to the central processing unit 11A through a serial port interface that is coupled to the system bus, but may be connected by other interfaces, such as a parallel port, game port or a universal serial bus (USB). A monitor 21A or other type of display device is also connected to the system bus via an interface, such as a video adapter. In addition to the monitor 21A, computers typically include other peripheral output devices (not shown), such as speakers and printers. The program modules may be practiced using any computer languages including C, C++, assembly language, and the like.

Some examples of the methods implemented for reviewing a collection of content data or documents to identify relevant documents from the collection in accordance with exemplary embodiments of the present invention are described below.

In one example (FIG. 6), a method for reviewing a content data or a vast collection of documents to identify relevant documents from the collection can entail a) running a search of the collection of documents based on a plurality of query terms and b) retrieving a subset of responsive documents from the collection (step S21A), 3) determining a corresponding probability of relevancy for each document in the responsive documents subset (step S23A) and 4) removing from the responsive documents subset, documents that do not reach a threshold probability of relevancy (step S25A).

The search techniques discussed in this disclosure are preferably automated as much as possible. Therefore, the search is preferably applied through a search engine. The search can include a concept search, and the concept search is applied through a concept search engine. Such searches and other automated steps or actions can be coordinated through appropriate programming, as would be appreciated by one skilled in the art.

The probability of relevancy of a document can be scaled according to a measure of obscurity of the search terms found in the document. The method can further comprise a) randomly selecting a predetermined amount of content data or a sample number of documents from the remaining content data found to be not relevant. and b) determining whether the randomly selected documents include additional relevant documents, and in addition, optionally, identifying one or more specific terms in the additional relevant documents that render the documents relevant, expanding the query terms with the specific terms, and re-running at least the search with the expanded query terms. In the event the randomly selected content data or documents include one or more additional relevant items of content data, the query terms can be expanded and the search run again with the expanded query terms. The method additionally comprises comparing a ratio of the additional relevant documents and the randomly selected documents to a predetermined acceptance level, to determine whether to apply a refined set of query terms.

The method further comprises the step of selecting two or more search terms, identifying synonyms of the search terms, and forming the query terms based on the search terms and synonyms.

The method further comprises the step of identifying a correspondence between a sender and a recipient, in the responsive documents subset, automatically determining one or more additional documents which are in a thread of the correspondence, the additional documents not being in the responsive documents subset, and adding the additional documents to the responsive documents subset. The term “correspondence” is used herein to refer to a written or electronic communication (for example, letter, memo, e-mail, text message, etc.) between a sender and a recipient, and optionally with copies going to one or more copy recipients.

The method further comprises the step of determining whether any of the documents in the responsive documents subset includes an attachment that is not in the responsive documents subset, and adding the attachment to the responsive documents subset. The method further comprises the step of applying a statistical technique (for example, zero-defect testing) to determine whether remaining documents not in the responsive documents set meet a predetermined acceptance level.

In one embodiment, the search includes (a) a Boolean search of the collection of documents based on the plurality of query terms, the Boolean search returning a first subset of responsive documents from the collection, and (b) a second search by applying a recall query based on the plurality of query terms to remaining ones of the collection of documents which were not returned by the Boolean search, the second search returning a second subset of responsive documents in the collection, and wherein the responsive documents subset is constituted by the first and second subsets. The first Boolean search may apply a measurable precision query based on the plurality of query terms. The method can optionally further include automatically tagging each document in the first subset with a precision tag, reviewing the document bearing the precision tag to determine whether the document is properly tagged with the precision tag, and determining whether to narrow the precision query and rerun the Boolean search with the narrowed query terms. The method can optionally further comprise automatically tagging each document in the second subset with a recall tag, reviewing the document bearing the recall tag to determine whether the document is properly tagged with the recall tag, and determining whether to narrow the recall query and rerun the second search with the narrowed query terms. The method can optionally further include reviewing the first and second subsets to determine whether to modify the query terms and rerun the Boolean search and second search with modified query terms.

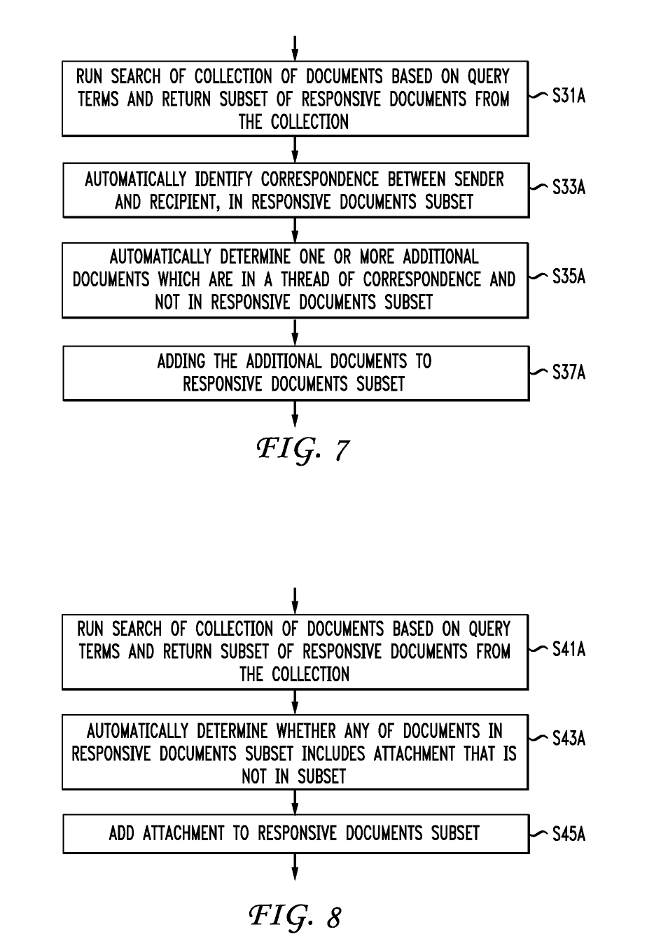

In another example (FIG. 7), a method for reviewing a collection of documents to identify relevant documents from the collection includes running a search of the collection of documents, based on a plurality of query terms, the search returning a subset of responsive documents in the collection (step S31A), automatically identifying a correspondence between a sender and a recipient, in the responsive documents subset (step S33A), automatically determining one or more additional documents which are in a thread of the correspondence, the additional documents not being in the responsive documents subset (step S35A), and adding the additional documents to the responsive documents subset (step S37A).

Some additional features which are optional include the following.

The method can further comprise determining for each document in the responsive documents subset, a corresponding probability of relevancy, and removing from the responsive documents subset documents that do not reach a threshold probability of relevancy. The probability of relevancy of a document can be scaled according to a measure of obscurity of the search terms found in the document.

The system and method further comprises applying a statistical technique to determine whether a remaining subset of the collection of documents not in the responsive documents subset meets a predetermined acceptance level.

The method additionally comprises the steps of a) randomly selecting a predetermined number of documents from a remainder of the collection of documents not in the responsive documents subset, b) determining whether the randomly selected documents include additional relevant documents, c) identifying one or more specific terms in the additional relevant documents that render the documents relevant, d) expanding the query terms with the specific terms, and e) running the search again with the expanded query terms.

The method further includes the steps of a) randomly selecting a predetermined number of content data or documents from a remainder of the collection of documents not in the responsive documents subset, b) determining whether the randomly selected documents include additional relevant documents, c) comparing a ratio of the additional relevant documents and the randomly selected documents to a predetermined acceptance level, and expanding the query terms and d) running the search with the expanded query terms, if the ratio does not meet the predetermined acceptance level.

The method further comprises the step of selecting two or more search terms, identifying synonyms of the search terms, and forming the query terms based on the search terms and synonyms.

The method additionally includes the step of determining whether any of the responsive content data or documents in the responsive documents subset includes an attachment that is not in the subset, and adding the attachment to the subset.

In another example (FIG. 8), a method for reviewing a collection of documents to identify relevant documents from the collection can comprise running a search of the collection of documents, based on a plurality of query terms, the search returning a subset of responsive documents in the collection (step S41A), automatically determining whether any of the responsive documents in the responsive documents subset includes an attachment that is not in the subset (step S43A), and adding the attachment to the responsive documents subset (step S45A).

Some additional features which are optional include the following.

The method further comprises determining for each document in the responsive documents subset, a corresponding probability of relevancy, and removing from the responsive documents subset documents that do not reach a threshold probability of relevancy. The probability of relevancy of a document is preferably scaled according to a measure of obscurity of the search terms found in the document.

The method additionally comprises applying a statistical technique to determine whether a remaining subset of the collection of documents not in the responsive documents subset meets a predetermined acceptance level.

The method further includes randomly selecting a predetermined number of documents from a remainder of the collection of documents not in the responsive documents subset, determining whether the randomly selected documents include additional relevant documents, identifying one or more specific terms in the additional responsive documents that render the documents relevant, expanding the query terms with the specific terms, running the search again with the expanded query terms.

The method further includes selecting two or more search terms, identifying synonyms of the search terms, and forming the query terms based on the search terms and synonyms.

The method further comprises identifying a correspondence between a sender and a recipient, in the responsive documents subset, automatically determining one or more additional documents which are in a thread of the correspondence, the additional documents not being in the responsive documents subset, and adding the additional documents to the responsive documents subset.

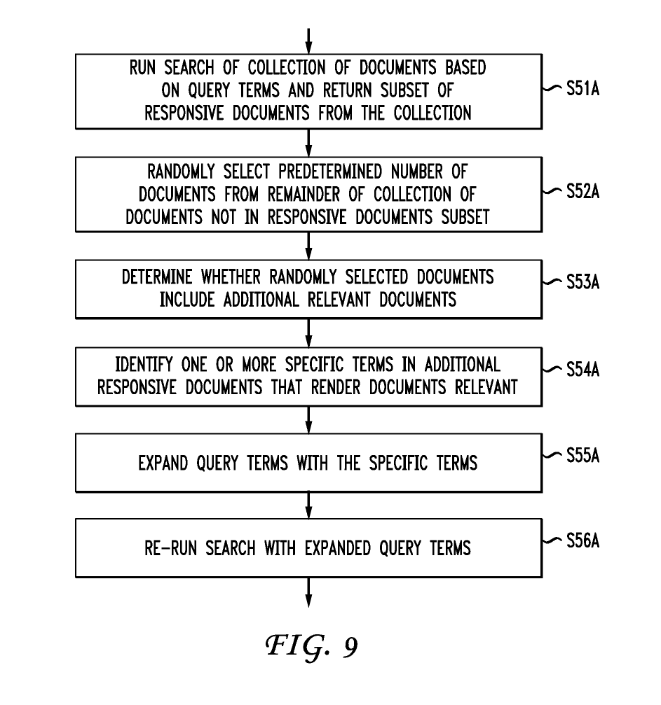

In another example (FIG. 9), a method for reviewing a collection of documents to identify relevant documents from the collection comprises running a search of the collection of documents, based on a plurality of query terms, the search returning a subset of responsive documents from the collection (step S51A), randomly selecting a predetermined number of documents from a remainder of the collection of documents not in the responsive documents subset (step S52A), determining whether the randomly selected documents include additional relevant documents (step S53A), identifying one or more specific terms in the additional responsive documents that render the documents relevant (step S54A), expanding the query terms with the specific terms (step S55A), and re-running the search with the expanded query terms (step S56A).

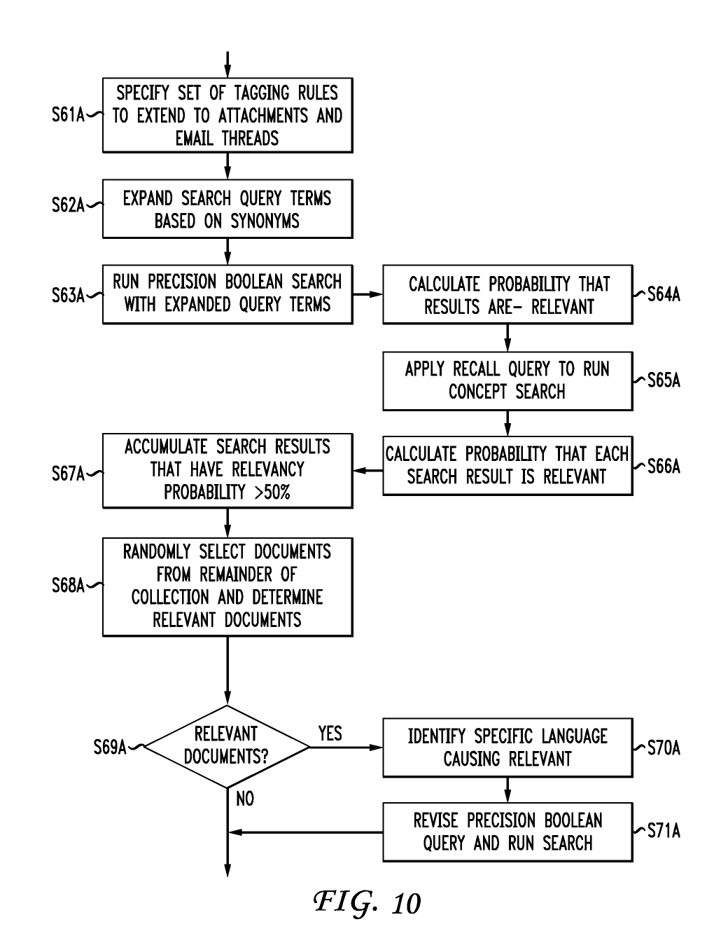

In another example (FIG. 10), a method for reviewing a collection of documents to identify relevant documents from the collection can comprise specifying a set of tagging rules to extend query results to include attachments and email threads (step S61A), expanding search query terms based on synonyms (step S62A), running a precision Boolean search of the collection of documents, based on two or more search terms and returning a first subset of potentially relevant documents in the collection (step S63A), calculating the probability that the results of each Boolean query are relevant by multiplying the probability of relevancy of each search term, where those individual probabilities are determined using an algorithm constructed from the proportion of relevant synonyms for each search term (step S64A), applying a recall query based on the two or more search terms to run a second concept search of remaining ones of the collection of documents which were not returned by the first Boolean search, the second search returning a second subset of potentially relevant documents in the collection (step S65A), calculating the probability that each search result in the recall query is relevant to a given topic based upon an ordering of the concept search results by relevance to the topic by vector analysis (step S66A), accumulating all search results that have a relevancy probability of greater than 50% into a subset of the collection (step S67A), randomly selecting a predetermined number of documents from the remaining subset of the collection and determining whether the randomly selected documents include additional relevant documents (step S68A), if additional relevant documents are found (step S69A, yes), identifying the specific language that causes relevancy, and expanding that language into a set of queries (step S70A), constructing and running precision Boolean queries of the entire document collection above (step S71A).

The following discussions of theory and exemplary embodiments are set forth to aid in an understanding of the subject matter of this disclosure but are not intended to, and should not be construed as, limiting in any way the invention as set forth in the claims which follow thereafter.

As discussed above, one of the problems with using conventional search engine techniques in culling a collection of content data or documents is that such techniques do not meet the requirements of recall and precision.

However, by using statistical sampling techniques it is possible to state with a defined degree of confidence the percentage of relevant documents that may have been missed. Assuming the percentage missed is set low enough (1%) and the confidence level is set high enough (99%), this statistical approach to identifying relevant documents would likely satisfy most judges in most jurisdictions. The problem then becomes how to select a subset of the document collection that is likely to contain all responsive documents. Failure to select accurate content data in the first place results in an endless cycle of statistical testing.

The probability that results from a simple Boolean search (word search) is relevant to a given topic and is directly related to the probability that the query terms themselves are relevant, i.e. that those terms are used within a relevant definition or context in the documents. Similarly, the likelihood that a complex Boolean query will return relevant documents is a function of the probability that the query terms themselves are relevant.

For example, the documents collected for review in today's lawsuits contain an enormous amount of email. It has been found that corporate email is not at all restricted to “business as such” usage. In fact, it is hard to distinguish between personal and business email accounts based on subject matter. As a consequence, even though a particular word may have a particular meaning within an industry, the occurrence of that word in an email found on a company server does not guarantee that is it has been used in association with its “business” definition.

An exemplary method for determining a probability of relevancy to a defined context is discussed below.

The following factors can be used to determine the probability that a word has been used in the defined context within a document: (1) the number of possible definitions of the word as compared to the number of relevant definitions; and (2) the relative obscurity of relevant definitions as compared to other definitions.

Calculation of the first factor is straightforward. If a word has five potential definitions (as determined by a credible dictionary) and if one of those definitions is responsive, then the basic probability that word is used responsively in any document retrieved during discovery is 20% (⅕). This calculation assumes, however, that all definitions are equally common, that they are all equally likely to be chosen by a writer describing the subject matter. Of course, that is generally not the case; some definitions are more “obscure” than others meaning that users are less likely to chose the word to impart that meaning. Thus, a measure of obscurity must be factored into the probability calculation.

A social networking approach can be taken to measure obscurity. The following method is consistent with the procedure generally used in the legal field currently for constructing query lists: (i) a list of potential query terms (keywords) is developed by the attorney team; (ii) for each word, a corresponding list of synonyms is created using a thesaurus; (iii) social network is drawn (using software) between all synonyms and keywords; (iv) a count of the number of ties at each node in the network is taken (each word is a node); (v) an obscurity factor is determined as the ratio between the number of ties at any word node and the greatest number of ties at any word node, or alternatively their respective z scores; and (vi) this obscurity factor is applied to the definitional probability calculated above.

The method described above calculates the probability that a given word is used in a relevant manner in a document. Boolean queries usually consist of multiple words, and thus a method of calculating the query terms interacting with each other is required.

The simplest complex queries consist of query terms separated by the Boolean operators AND and/or OR. For queries separated by an AND operator, the individual probabilities of each word in the query are multiplied together to yield the probability that the complex query will return responsive results. For query terms separated by an OR operator, the probability of the query yielding relevant results is equal to the probability of the lowest ranked search term in the query string.

Query words strung together within quotation marks are typically treated as a single phrase in Boolean engines (i.e. they are treated as if the string is one word). A document is returned as a result if and only if the entire phrase exists within the document. For purposes of calculating probability, the phrase is translated to its closest synonym and the probability of that word is assigned to the phrase. Moreover, since a phrase generally has a defined part of speech (noun, verb, adjective, etc.), when calculating probability one considers only the total number of possible definitions for that part of speech, thereby reducing the denominator of the equation and increasing the probability of a responsive result.

Complex Boolean queries can take the form of “A within X words B”, where A and B are query terms and X is the number of words in separating them in a document which is usually a small number. The purpose of this type of query, called a proximity query, is to define the terms in relation to one another. This increases the probability that the words will be used responsively. The probability that a proximity query will return responsive documents equals the probability of the highest query term in the query will be responsive.

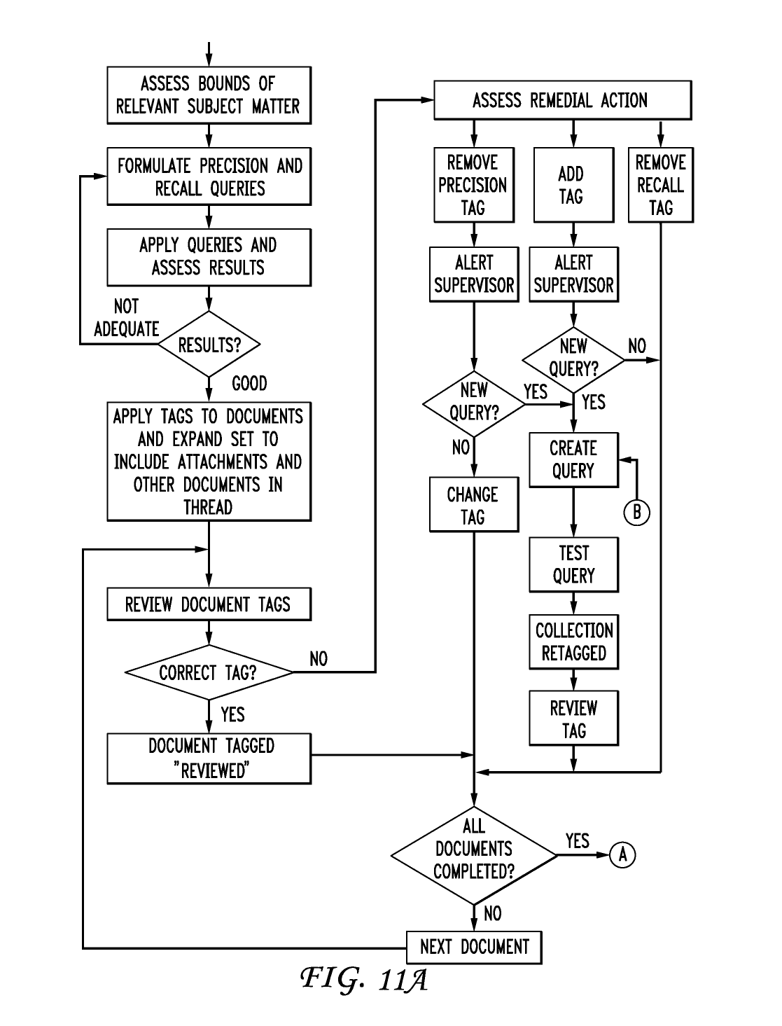

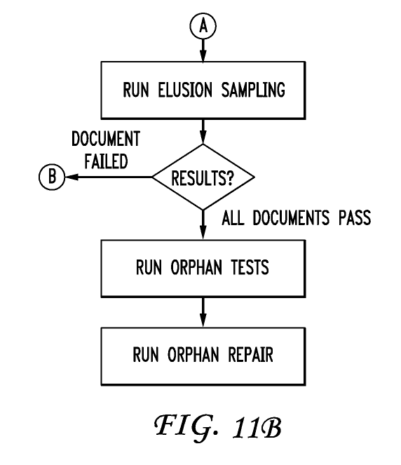

A workflow of a process including application of some of the techniques discussed herein, according to one example, is shown exemplarily in FIGS. 11A and 11B.

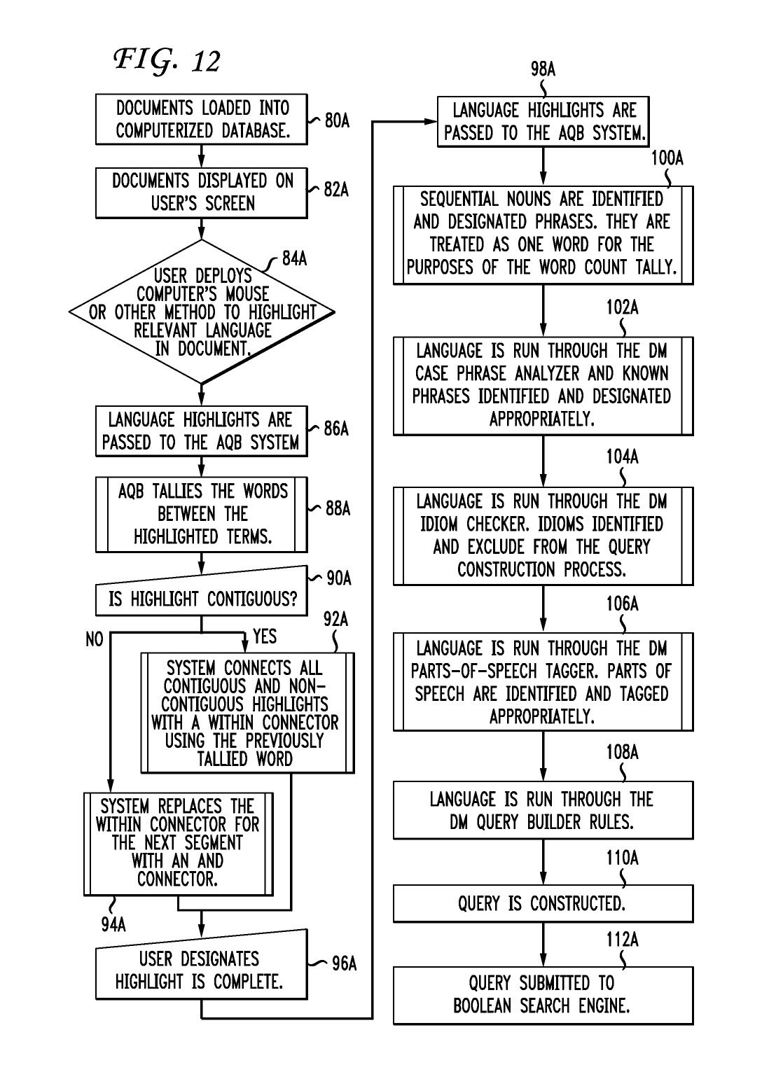

FIG. 12 is a flow chart of the automated query builder feature of the present system and method. This aspect includes operations whereby content data or documents are loaded into a database, illustrated by block 80A. The content data or documents may be displayed on the user's screen (shown at 82A). The user may use a computer mouse or other method to highlight the relevant text in the content data or document, as illustrated by reference numeral 84A. The highlighted text is forwarded to the automatic query builder routine in the system (see block 86A). As illustrated by block 88A, the automatic query builder routine tallies the words between the highlighted terms. The system ensures that the highlighting is contiguous (see 90A). If it is, the system connects all contiguous and non-contiguous highlights within a connector using the previously tallied word counts (see block 92A). If it is not, the system replaces the within connector for the next segment with an AND connector (see 94A). Following these operations, the user designates that the highlighting is complete (see 96). The highlighted section is passed to the automatic query builder, at 98A.

The automatic query builder identifies sequential nouns and designated phrases. These are treated as a single word for the purpose of the word count tally (indicated by reference numeral 100A). Following this operation, the text is run through the case phrase analyzer, where known phrases are identified and appropriately designated (see 102A). The language is run through the idiom checker (see 104A) where idioms are identified and excluded from the query construction process. After this operation, the text is run through a parts-of-speech tagger routine (106A). This routine identifies parts of speech and appropriately tags them. Finally, the text is run through the system query builder rules (shown at 108A) and a query is constructed (see step 110A). Once a query is constructed, the system submits the query to the Boolean search engine at 112A.

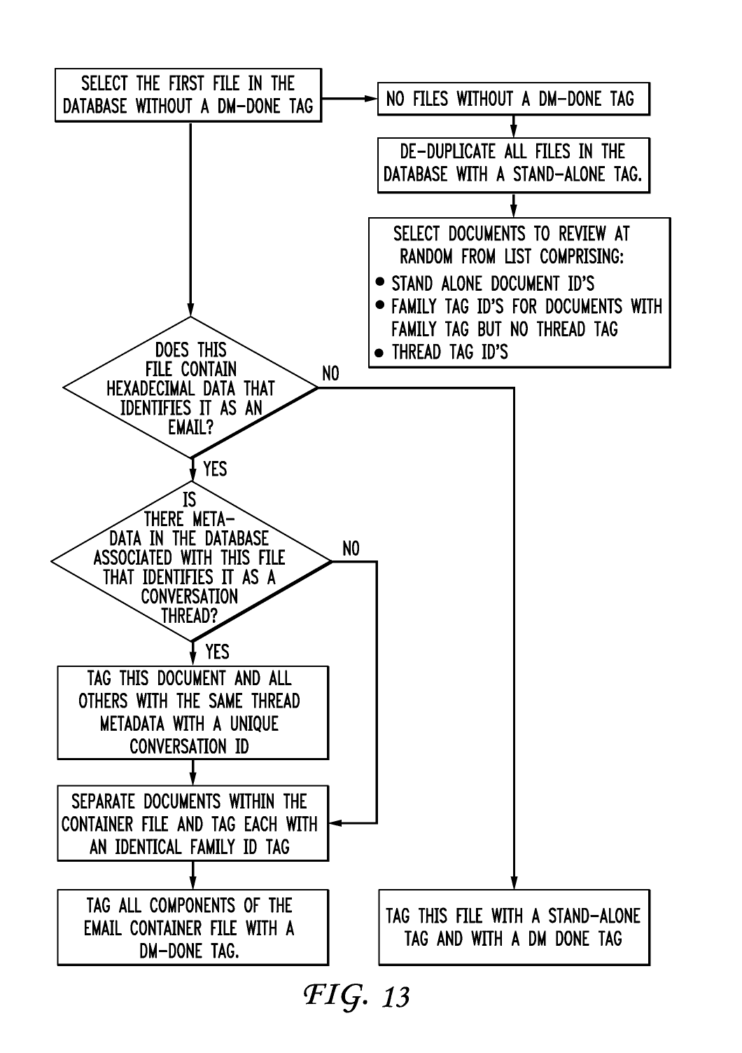

FIG. 13 illustrates the way related content data is identified and ultimately tagged. For example, in a database of a corporate network containing emails, attachments and stand alone files, the system considers all content data in a thread of correspondence (for example, an e-mail) and includes it in the subset of relevant data. The system also scans the content data in the thread and automatically identifies other data of interest, for example, contained in attachments and includes that as well.

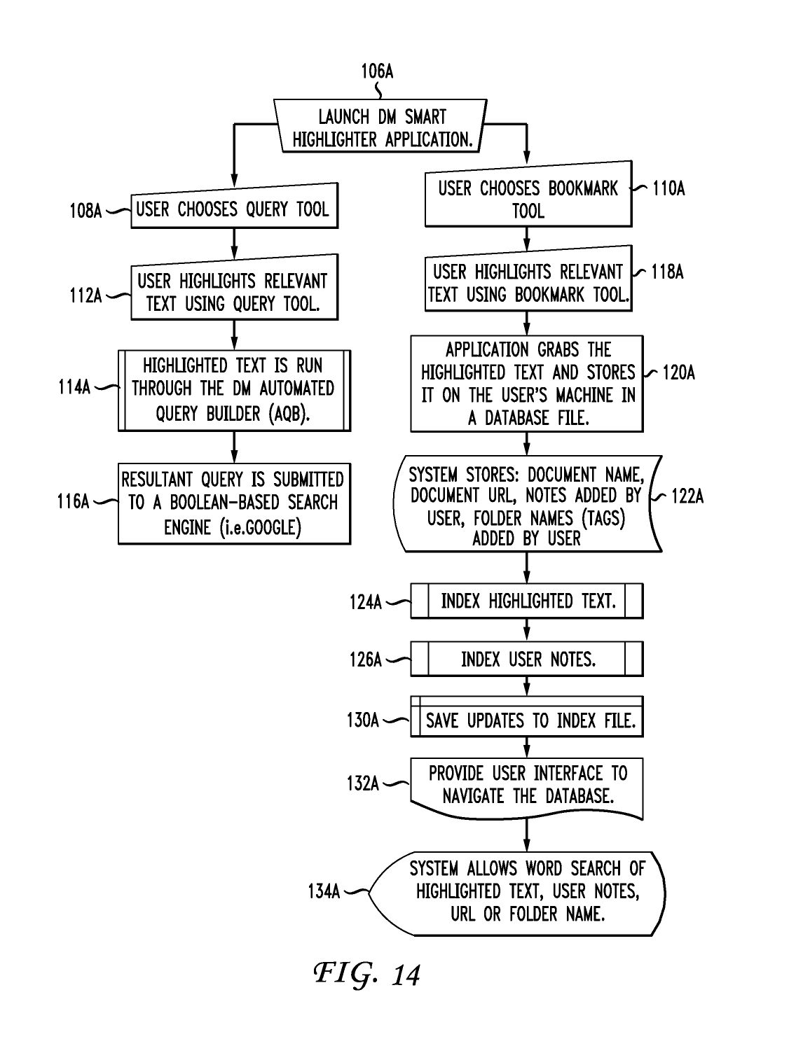

FIG. 14 illustrates a flow chart representing the steps used in a “smart highlighter” routine of the system. This routine is launched (106A) allowing the user to select either a query tool (see 108A) or a bookmark tool (see 110A). In the event the user chooses a query tool, the user can use it to highlight any text of interest (see 112A). The highlighted text is run through an automated query builder (see 114A) and the resulting query is submitted to the Boolean-based search engine (116A).

In the event the user chooses the bookmark tool, the user highlights any text of interest with the bookmark tool (see 118A). The system takes the highlighted text and stores it on the user's computer machine in a database file (see 120A). At operation 122A, the system stores the document name, document URL, any notes added by the user, folder names (tags) added by the user. Following this, the system indexes the highlighted text (124A), the user notes (126A) and saves updates to the index file (130A). The user may navigate the database via a user interface (132A) as the system allows a word search of the highlighted text, user notes, URL or folder name etc. (134A).

The specific embodiments and examples described herein are illustrative, and many variations can be introduced on these embodiments and examples without departing from the spirit of the disclosure or from the scope of the appended claims. For example, features of different illustrative embodiments and examples may be combined with each other and/or substituted for each other within the scope of this disclosure and appended claims.

### REFERENCES

Herbert L. Roitblat, “Electronic Data Are Increasingly Important To Successful Litigation” (November 2004).
Herbert L. Roitblat, “Document Retrieval” (2005).
“The Sedona Principles: Best Practices Recommendations & Principles for Addressing Electronic Document Production” (July 2005 Version).

What is claimed is:

1. A method for reviewing document data to isolate irrelevant data, the method utilizing a computer system including a computer processor and at least one or more memories with stored data in electronic form relating to a collection documents, the method comprising the steps of:
utilizing the computer processor to run a search of a first subset of document data, the search configured to utilize at least one or more query terms relating to an issue defined by a user of the computer system,
subsequently utilizing the computer processor to create a Boolean query utilizing the plurality of query terms and to automatically create a Boolean query by applying certain criteria to refine the search, and
isolating a second subset of document data that is irrelevant to the Boolean query in order to permit the user to discard the irrelevant document data before continuing a further search.
